(19) United States
(12) Patent Application Publication
(10) Pub. No.: US 2007/0040899 A1
(43) Pub. Date: Feb. 22, 2007

(54) Videophone apparatus and videophone

(76) Inventor: Katsunori Takahashi, Yokohama-City (JP)

Correspondence Address: BRINKS HOFER GILSON & LIONE, P.O. BOX 10395, CHICAGO, IL, 60610, US

(21) Appl. No.: 11/442,692

(22) Filed: May 26, 2006

(30) Foreign Application Priority Data
May 27, 2005 (JP) 2005-154790

(51) Int. Cl. H04N 7/14

(52) U.S. Cl. 348/14.08

(57) ABSTRACT

In a videophone apparatus or system, capability information acquired by capability information exchange is stored. Upon issuance or reception of a call request to or from a videophone apparatus having a predetermined phone number to thereby make a subsequent phone call to a remote videophone, an interconnection with the remote videophone is established using the stored capability information.

### BACKGROUND OF THE INVENTION

1. Field of the Invention

The present invention relates to videophone apparatuses and videophone apparatuses. More particularly, the present invention relates to a videophone apparatus and videophone system which are preferably used for transmitting/receiving image data together with voice data to/from a remote-side videophone apparatus through a communications line to make a phone call (including phone communication and/or phone conversation) involving the display of the image data received from the remote-side videophone apparatus.

2. Description of the Related Art

Typically, videophones incorporated into 3G (third generation) mobile phones based on FOMA™, Vodafone™, and so on establish interconnection in accordance with the 3G-324M standard defined by the 3GPP (3rd Generation Partnership Project).

After an interconnection is established, image data and voice data are mutually transmitted and received to thereby make it possible to make a phone call involving the display of the image data received from the remote-side terminal (videophone).

In the 3G-324M standard, with regard to terminal functions, such as a CODEC (COder-DECoder) function, multiplexing function, and control function, capability information exchange is performed between terminals at the start of communication in order to achieve the compatibility of interconnection (e.g., refer to Japanese Unexamined Patent Application Publication No. 2000-316055).

The capability information exchange is performed, for example, to determine a multiplexing level, to determine a master/slave relationship, to exchange terminal information such as CODEC capabilities and multiplexing tables, and to establish a logic channel.

After such capability information exchange is performed, an interconnection is appropriately established.

However, since a large amount of information needs to be exchanged during the capability information exchange, a waiting time of about 5 to 20 seconds is required from when a call request is issued to a remote-side videophone apparatus until video and voice are generated output.

Consequently, there are some problems. Specifically, a videophone call to the remote-side videophone apparatus cannot be promptly started. Further, during the waiting time, an actual data communications line is connected while an interconnection is not established. Thus, the connection fee is charged to the user.

### SUMMARY OF THE INVENTION

Accordingly, the present invention has been made in view of such problems, and an object of the present invention is to provide a videophone and videophone system which can reduce waiting time until a videophone call is started and which can reduce a connection fee charged to the user.

To achieve the foregoing object, the present invention provides a videophone. The videophone (hereinafter may be referred to a “first videophone apparatus”) stores capability information acquired by capability information exchange performed during a previous phone call. When the first videophone apparatus issues or receives a call request to or from another videophone having a predetermined phone number corresponding to a remote videophone phone number used during the previous phone call and makes a subsequent phone call to the remote videophone, the first videophone apparatus establishes an interconnection with the remote videophone by using the stored capability information.

With this arrangement, capability information acquired by capability information exchange during a previous phone call to the remote videophone can be stored and the stored capability information can be used to establish an interconnection for a subsequent phone call to the remote videophone.

Herein, the capability information exchange refers to processing mutually performed between one videophone apparatus and a remote videophone (e.g., the above-noted remote videophone) (which may be multiple videophone apparatuses) to establish an interconnection between the one videophone apparatus and the remote videophone. This processing is defined to involve at least the exchange of terminal information (e.g., CODEC capabilities and multiplexing tables) required for establishing the interconnection.

Herein, the capability information acquired by the capability information exchange refers to capability information acquired by the one videophone apparatus and capability information acquired by the remote videophone through the capability information exchange defined above. When the one videophone apparatus and the remote videophone share each piece of the capability information, they can establish an interconnection therebetween by using the information. The capability information contains at least remote terminal information.

Preferably, the first videophone determines whether or not the second videophone having the predetermined phone number, during the issuance or reception of the call request for the subsequent phone call, is the remote videophone of interest. When it is determined that the second videophone is the remote videophone, the first videophone establishes an interconnection with the remote videophone by using the stored capability information.

With this arrangement, after a videophone-apparatus identity that corresponds to a phone number is determined, an interconnection for the subsequent phone call to the remote videophone can be established using the stored capability information.

Preferably, the first videophone exchanges a call identifier, issued by the first videophone, for identifying the n-th call and a call identifier, issued by the remote videophone, for identifying the n-th call. The first videophone stores the call identifier issued by the remote videophone and acquired by the exchange. When a second videophone having the predetermined phone number, during the issuance or reception of a call request for the (n+1)th phone call, holds a call identifier, the first videophone exchanges the call identifier held by the second videophone and the call identifier issued by the remote videophone and stored. When the call identifier issued by the first videophone is acquired by the exchange, the first videophone determines that the second videophone during the issuance or reception of the call request for the (n+1)th phone is the remote videophone of interest.

With this arrangement, based on the call identifier, that is, based on whether or not a call identifier, issued by the first videophone, for identifying the n-th phone call is obtained by the call-identifier exchange performed with the second videophone during the (n+1)th phone call, a videophone identity that corresponds to a phone number can be determined.

Preferably, the first videophone exchanges a call identifier, issued by the first videophone, for identifying the n-th call and a call identifier, issued by the remote videophone, for identifying the n-th call. The first videophone stores the call identifier issued by the remote videophone and acquired by the exchange. When a second videophone having the predetermined phone number, during the issuance or reception of a call request for the (n+1)th phone call, holds a call identifier previously issued by the second videophone, the first videophone exchanges the call identifier held by the second videophone and the call identifier issued by the first videophone, and when the call identifier issued by the remote videophone and stored is acquired by the exchange, the first videophone determines that the second videophone during the issuance or reception of the call request for the (n+1)th phone call is the remote videophone of interest.

With this arrangement, based on the call identifier, that is, based on whether or not a call identifier, issued by the remote videophone and stored, for identifying the n-th phone call is obtained by the call-identifier exchange performed with the second videophone during the (n+1)th phone call, a videophone identity that corresponds to a phone number can be determined.

Preferably, the first videophone stores a set of phone number information of the remote videophone, the capability information acquired by the capability information exchange, and the call identifier issued by the remote videophone and acquired by the exchange of the call identifiers.

With this arrangement, the phone number information of the remote videophone, the capability information acquired by the capability information exchange, and the call identifier issued by the remote videophone and acquired by the call identifier exchange can be promptly read. Thus, an interconnection with the remote videophone can be efficiently established based on the determination of a videophone identity that corresponds to a phone number and based on the stored capability information.

In addition, the call identifiers may contain time information indicating time when the call identifiers are issued.

With this arrangement, it is possible to issue call identifiers containing simple information that allows appropriate determination of a videophone identity that corresponds to a phone number.

Additionally, in the videophone apparatus of the present invention, the time information may contain date and time.

With this arrangement, it is possible to issue call identifiers that allow more appropriate determination of a videophone identity that corresponds to a phone number.

Preferably, when the communications line is disconnected after the n-th phone call to the remote videophone is finished, the first videophone issues and exchanges the call identifier for identifying the n-th phone call.

With this arrangement, it is possible to issue and exchange call identifiers for identifying the n-th phone call, at a point when the phone call is not affected.

When the first videophone issues or receives the call request for the subsequent phone call but fails to establish an interconnection with the remote videophone by using the stored capability information, the first videophone may perform capability information exchange with the remote videophone to establish the interconnection by using capability information acquired by the capability information exchange.

With this arrangement, even when the establishment of an interconnection with the remote videophone by using the stored capability information fails, the interconnection can be established by performing capability information exchange.

Additionally, the videophone apparatuses of the present invention may be incorporated into a mobile communication terminal.

With this arrangement, the videophone apparatus incorporated into a mobile communication terminal can store capability information acquired by capability information exchange performed during the previous phone call to the remote videophone and can establish an interconnection for a subsequent phone call to the remote videophone by using the stored capability information.

The videophone apparatuses of the present invention may be incorporated into a vehicle-mounted navigation apparatus and image data may be displayed on a display unit of the navigation apparatus.

With this arrangement, the videophone apparatus incorporated into a vehicle-mounted navigation apparatus can also store capability information acquired by capability information exchange performed during the previous phone call to the remote videophone and can establish an interconnection for a subsequent phone call to the remote videophone by using the stored capability information.

The videophone of the present invention is capable of performing at least part of the capability information exchange with the remote videophone in advance, without issuing or receiving a call request to or from the remote videophone.

With this arrangement, it is possible to perform at least part of the capability information exchange with a remote videophone to which a phone call has never been made.

In addition, the videophone of the present invention may simultaneously make a phone call to multiple remote videophone.

With this arrangement, even when the videophone simultaneously makes a phone call to multiple remote videophone, the videophone can store capability information acquired by capability information exchange performed during the previous phone call to each remote videophone and can establish an interconnection for a subsequent phone call to each remote videophone by using the stored capability information.

The present invention provides a videophone system. The videophone system includes multiple videophone apparatuses that include a first videophone and at least one remote videophone having a predetermined phone number. When the first-videophone issues or receives a call request to or from a videophone having a predetermined phone number corresponding to a remote videophone phone number used during the previous phone call and makes a subsequent phone call to the remote videophone, the first videophone establishes an interconnection with the remote videophone by using the stored capability information.

With this arrangement, the first videophone can store capability information acquired by capability information exchange performed during the previous phone call to a remote videophone and can establish an interconnection for a subsequent phone call to the remote videophone by using the stored capability information.

In the videophone system of the present invention, preferably, the first videophone determines whether or not a second videophone having the predetermined phone number, during the issuance or reception of the call request for the subsequent phone call, is the remote videophone. When it is determined that the second videophone is the remote videophone, the first videophone establishes an interconnection with the remote videophone by using the stored capability information.

With this arrangement, after determining a videophone apparatus identity that corresponds to a phone number, the first videophone of the multiple videophone apparatuses can establish an interconnection for a subsequent phone call to the remote videophone by using the stored capability information.

In the videophone system of the present invention, preferably, the first videophone exchanges a call identifier, issued by the first videophone, for identifying the n-th call and a call identifier, issued by the remote videophone, for identifying the n-th call. The first videophone stores the call identifier issued by the remote videophone and acquired by the exchange. When a second videophone having the predetermined phone number, during the issuance or reception of a call request for the (n+1)th phone call, holds a call identifier, the first videophone exchanges the call identifier held by the second videophone and the call identifier issued by the remote videophone and stored. When the call identifier issued by the first videophone is acquired by the exchange, the first videophone determines that the second videophone during the issuance or reception of the call request for the (n+1)th phone is the remote videophone.

With this arrangement, based on the call identifier, that is, based on whether or not a call identifier, issued by the first videophone, for identifying the n-th phone call is obtained by the call-identifier exchange performed with the second videophone during the (n+1)th phone call, the first videophone can determine a videophone apparatus identity that corresponds to a phone number.

In the videophone system of the present invention, preferably, the first videophone exchanges a call identifier, issued by the first videophone, for identifying the n-th call and a call identifier, issued by the remote videophone, for identifying the n-th call. The first videophone stores the call identifier issued by the remote videophone and acquired by the exchange. When a second videophone having the predetermined phone number, during the issuance or reception of a call request for the (n+1)th phone call, holds a call identifier previously issued by the second videophone, the first videophone exchanges the call identifier held by the second videophone and the call identifier issued by the first videophone. When the call identifier issued by the remote videophone and stored is acquired by the exchange, the first videophone determines that the second videophone during the issuance or reception of the call request for the (n+1)th phone call is the remote videophone.

With this arrangement, based on the call identifier, that is, based upon whether or not the call identifier, issued by the first videophone, for identifying the n-th phone call is obtained by the call-identifier exchange performed with the second videophone during the (n+1)th phone call, the first videophone can determine a videophone apparatus identity that corresponds to a phone number.

In the videophone system, preferably, the first videophone stores a set of phone number information of the remote videophone, the capability information acquired by the capability information exchange, and the call identifier issued by the remote videophone and acquired by the exchange of the call identifiers.

With this arrangement, the first videophone can promptly read the phone number information of the remote videophone, the capability information acquired by the capability information exchange, and the call identifier issued by the remote videophone and acquired by the call identifier exchange. Thus, the first videophone can efficiently establish an interconnection with the remote videophone, based on the determination of a videophone apparatus identity that corresponds to a phone number and based on the stored capability information.

In the videophone system of the present invention, the call identifiers may contain time information indicating time when the call identifiers are issued.

With this arrangement, it is possible to issue call identifiers containing simple information that allows appropriate determination of a videophone apparatus identity that corresponds to a phone number.

In the videophone system of the present invention, the time information may contain date and time.

With this arrangement, it is possible to issue call identifiers that allow more appropriate determination of a videophone apparatus identity that corresponds to a phone number.

In the videophone system of the present invention, preferably, the first videophone issues and exchanges the call identifier for identifying the n-th phone call, when the communications line is disconnected after the n-th phone call to the remote videophone is finished.

With this arrangement, each videophone apparatus can issue and exchange call identifiers at a point when a phone call is not affected.

In the videophone system of the present invention, when the first videophone issues or receives a call request for the subsequent phone call but fails to establish an interconnection with the remote videophone by using the mutually stored capability information, the first videophone may perform capability information exchange with the remote videophone to establish the interconnection by using capability information acquired by the capability information exchange.

With this arrangement, even when first videophone fails to establish an interconnection with the remote videophone by using the stored capability information, the first videophone can establish an interconnection by performing capability information exchange.

In the videophone system of the present invention, at least one of the multiple videophone apparatuses is incorporated into a mobile communication terminal.

With this arrangement, the videophone apparatus incorporated into a mobile communication terminal can store capability information acquired by capability information exchange performed during the previous phone call to the remote videophone and can establish an interconnection for a subsequent phone call to the remote-side videophone apparatus by using the stored capability information.

In the videophone system of the present invention, at least one of the multiple videophone apparatuses may be is incorporated into a vehicle-mounted navigation apparatus and image data may be displayed on a display unit of the navigation apparatus.

With this arrangement, the videophone apparatus incorporated into a vehicle-mounted navigation apparatus can store capability information acquired by capability information exchange performed during the previous phone call to the remote videophone and can establish an interconnection for a subsequent phone call to the remote videophone by using the stored capability information.

In the videophone system of the present invention, the videophone is capable of performing at least part of the capability information exchange with the remote videophone in advance, without issuing or receiving a call request to or from the phone number of the remote videophone.

With this arrangement, it is possible to perform at least part of the capability information exchange with a remote videophone to which a phone call has never been made.

Additionally, in the videophone system of the present invention, at least one of the multiple videophone apparatuses simultaneously may make a phone call to multiple remote videophone.

With this arrangement, even when the videophone apparatus simultaneously makes a phone call to multiple remote videophone apparatuses, the videophone can store capability information acquired by capability information exchange performed during the previous phone call to each remote videophone apparatus and can establish an interconnection for a subsequent phone call to each remote videophone apparatus by using the stored capability information.

According to the videophone of the present invention, capability information acquired by capability information exchange performed during the previous phone call to the remote videophone can be stored and an interconnection for a subsequent phone call to the remote videophone can be established by using the stored capability information. Consequently, it is possible to provide a videophone that can further reduce waiting time until a videophone call is started and that can reduce a connection fee charged to the user.

According to the videophone apparatus of the present invention, after a videophone apparatus identity that corresponds to a phone number is determined, an interconnection for a subsequent phone call to the remote videophone can be established using the stored capability information. Consequently, it is possible to verify that a communication partner during a subsequent phone call is the partner to whom a phone call has previously been made, and it is possible to effectively use the capability information stored during the previous phone call. Thus, it is possible to provide a videophone that can further reduce waiting time until a videophone call is started and that can reduce a connection fee charged to the user.

In addition, during the (n+1)th call, the first videophone can exchange call identifiers with a videophone apparatus having a predetermined number. Based on whether or not the call identifier, issued by the first videophone, for identifying the n-th call is obtained by the call-identifier exchange, a videophone apparatus identity that corresponds to a phone number can be determined. Consequently, with a simple configuration, it is possible to achieve a videophone that can reduce waiting time until a videophone call is started and that can reduce a connection fee charged to the user.

Additionally, during the (n+1)th call, the first videophone can exchange call identifiers with a videophone apparatus having a predetermined number. Based on whether or not the call identifier, issued by the remote videophone and stored, for identifying the n-th call is obtained by the call-identifier exchange, a videophone apparatus identity that corresponds to a phone number can be determined. With a simple configuration, it is possible to achieve a videophone that can reduce waiting time until a videophone call is started and that can reduce a connection fee charged to the user.

According to the videophone apparatus of the present invention, the phone number information of the remote videophone, the capability information acquired by the capability information exchange, and the call identifier issued by the remote videophone and acquired by the call identifier exchange can be promptly read. Thus, an interconnection with the remote videophone can be efficiently established based on the determination of a videophone apparatus identity that corresponds to a phone number and based on the stored capability information. Consequently, it is possible to achieve a videophone that can further reduce waiting time until a videophone call is started and that can reduce a connection fee charged to the user. Thus, it is possible to achieve a videophone that can reduce waiting time until a videophone call is started and that can reduce a connection fee charged to the user.

In addition, according to the videophone apparatus of the present invention, it is possible to issue call identifiers containing simple information that allows appropriate determination of a videophone apparatus identity that corresponds to a phone number. Consequently, with a simpler configuration, it is possible to achieve a videophone that can reduce waiting time until a videophone call is started and that can reduce a connection fee charged to the user.

Additionally, according to the videophone apparatus of the present invention, it is possible to issue call identifiers that allow more appropriate determination of a videophone apparatus identity that corresponds to a phone number. Consequently, with a simpler configuration, it is possible to achieve a videophone that can reduce waiting time until a videophone call is started and that can reduce a connection fee charged to the user.

According to the videophone apparatus of the present invention, it is possible to issue and exchange call identifiers at a point when a phone call is not affected. Consequently, it is possible to achieve a videophone that allows a videophone call to be made more appropriately.

In addition, according to the videophone apparatus of the present invention, even when the establishment of an interconnection with the remote videophone by using the stored capability information fails, the interconnection can be established by performing the capability information exchange. Consequently, it is possible to achieve a videophone that allows a videophone call to be made more appropriately.

Additionally, according to the videophone apparatus of the present invention, the videophone apparatus incorporated into a mobile communication terminal can store capability information acquired by capability information exchange performed during the previous phone call to the remote videophone and can establish an interconnection for a subsequent phone call to the remote videophone by using the stored capability information. Consequently, it is possible to achieve a videophone apparatus for a mobile communication terminal that is capable of reducing waiting time until a videophone call is started and that is capable of reducing a connection fee charged to the user.

Additionally, according to the videophone apparatus of the present invention, the videophone apparatus incorporated into a vehicle-mounted communication apparatus can store capability information acquired by capability information exchange performed during the previous phone call to the remote videophone and can establish an interconnection for a subsequent phone call to the remote videophone by using the stored capability information. Consequently, it is possible to achieve a videophone apparatus for a vehicle-mounted communication apparatus that is capable of reducing waiting time until a videophone call is started and that is capable of reducing a connection fee charged to the user.

In addition, according to the videophone apparatus of the present invention, it is possible to perform at least part of the capability information exchange with a remote videophone to which a phone call has never been made. Consequently, even for a communication partner to whom a phone call is to be made for the first time, the videophone apparatus can reduce waiting time until a videophone call is started and that can reduce a connection fee charged to the user.

Additionally, according to the videophone apparatus of the present invention, even when the videophone apparatus simultaneously makes a phone call to multiple remote videophone apparatuses, the videophone apparatus can store capability information acquired by capability information exchange performed during the previous phone call to each remote videophone apparatus and can establish an interconnection for a subsequent phone call to each remote videophone apparatus by using the stored capability information. Consequently, when simultaneously making a phone call to multiple remote videophone apparatuses, the videophone apparatus can reduce waiting time until a videophone call is started and that can reduce a connection fee charged to the user.

According to the videophone system of the present invention, the multiple videophone apparatuses can mutually store capability information acquired by capability information exchange performed during the previous phone call to a remote videophone apparatus and can establish an interconnection for a subsequent phone call to the remote videophone apparatus by using the stored capability information. Consequently, it is possible to achieve a videophone system that can reduce waiting time until a videophone call is started and that can reduce a connection fee charged to the user.

According to the videophone system of the present invention, after determining a videophone apparatus identity that corresponds to a phone number, each videophone apparatus can establish an interconnection for a subsequent phone call to a remote videophone apparatus by using the stored capability information. Consequently, it is possible to verify that a communication partner during a subsequent phone call is the partner to whom a phone call has previously been made, and it is possible to effectively use the capability information stored during the previous phone call. Thus, it is possible to provide a videophone system that can further reduce waiting time until a videophone call is started and that can reduce a connection fee charged to the user.

Additionally, in the videophone system of the present invention, during the (n+1)th call, the first videophone apparatus of the videophone apparatuses can exchange call identifiers with a videophone apparatus having a predetermined number. Based on whether or not the call identifier, issued by the first videophone apparatus, for identifying the n-th call is obtained by the call-identifier exchange, a videophone apparatus identity that corresponds to a phone number can be determined. Consequently, with a simple configuration, it is possible to achieve a videophone system that can reduce waiting time until a videophone call is started and that can reduce a connection fee charged to the user.

Additionally, during the (n+1)th call, the first videophone apparatus of the videophone apparatuses can exchange call identifiers with a videophone apparatus having a predetermined number. Based on whether or not the call identifier, issued by the remote-side videophone apparatus and stored, for identifying the n-th call is obtained by the call-identifier exchange, a videophone apparatus identity that corresponds to a phone number can be determined. Consequently, with a simple configuration, it is possible to achieve a videophone system that can reduce waiting time until a videophone call is started and that can reduce a connection fee charged to the user.

Additionally, according to the videophone system of the present invention, the first videophone apparatus of the videophone apparatuses can promptly read the phone number information of a remote videophone apparatus, the capability information acquired by the capability information exchange, and the call identifier issued by the remote videophone apparatus and acquired by the call identifier exchange. Thus, the first videophone apparatus can efficiently establish an interconnection with the remote videophone apparatus, based on the determination of a videophone apparatus identity that corresponds to a phone number and based on the stored capability information. Consequently, with a simple configuration, it is possible to achieve a videophone system that can further reduce waiting time until a videophone call is started and that can further reduce a connection fee charged to the user.

Moreover, according to the videophone system of the present invention, each videophone apparatus can issue a call identifier containing simple information that allows appropriate determination of a videophone apparatus identity that corresponds to a phone number. Consequently, with a simpler configuration, it is possible to achieve a videophone system that can reliably reduce waiting time until a videophone call is started and that can reliably reduce a connection fee charged to the user.

Additionally, according to the videophone system of the present invention, each videophone apparatus can issue a call identifier that allows more appropriate determination of a videophone apparatus identity that corresponds to a phone number. Consequently, with a simpler configuration, it is possible to achieve a videophone system that can reliably reduce waiting time until a videophone call is started and that can reliably reduce a connection fee charged to the user.

According to the videophone system of the present invention, the multiple videophone apparatuses can issue and exchange call identifiers at a point when a phone call is not affected. Consequently, it is possible to achieve a videophone system that allows a videophone call to be made more appropriately.

In addition, according to the videophone system of the present invention, even when each videophone apparatus fails to establish an interconnection with a remote videophone apparatus by using the stored capability information, the interconnection can be established by performing capability information exchange. Consequently, it is possible to achieve a videophone system that allows a videophone call to be made more appropriately.

Additionally, according to the videophone system of the present invention, the videophone system incorporated into a mobile communication terminal can also store capability information acquired by capability information exchange performed during the previous phone call to a remote-side videophone apparatus and can establish an interconnection for a subsequent phone call to the remote videophone apparatus by using the stored capability information. Consequently, it is possible to achieve a videophone system for a mobile communication terminal that is capable of reducing waiting time until a videophone call is started and that is capable of reducing a connection fee charged to the user.

Additionally, according to the videophone system of the present invention, the videophone system incorporated into a vehicle-mounted communication apparatus can also store capability information acquired by capability information exchange performed during the previous phone call to a remote videophone apparatus and can establish an interconnection for a subsequent phone call to the remote videophone apparatus by using the stored capability information. Consequently, it is possible to achieve a videophone system for a vehicle-mounted communication apparatus that is capable of reducing waiting time until a videophone call is started and that is capable of reducing a connection fee charged to the user.

In addition, according to the videophone system of the present invention, it is possible to perform at least part of the capability information exchange with a remote videophone apparatus to which a phone call has never been made. Consequently, even for a communication partner to whom a phone call is to be made for the first time, the videophone system can reduce waiting time until a videophone call is started and that can reduce a connection fee charged to the user.

Additionally, according to the videophone system of the present invention, even when a phone call is simultaneously made to multiple remote-side videophone apparatuses, capability information acquired by capability information exchange performed during the previous phone call to each remote videophone apparatus can be stored and an interconnection for a subsequent phone call to each remote videophone apparatus can be established by using the stored capability information. Consequently, when a phone call is simultaneously made to multiple remote videophone apparatuses, the videophone system can reduce waiting time until a videophone call is started and that can reduce a connection fee charged to the user.

### BRIEF DESCRIPTION OF THE DRAWINGS

FIG. 1 is a block diagram showing a videophone system according to a first embodiment of the present invention;

FIG. 2 is a flow diagram showing an operation sequence of the videophone system in the embodiment of the present invention;

FIG. 3 is a block diagram showing the hardware configuration of a videophone apparatus incorporated into a vehicle-mounted navigation apparatus according to a second embodiment of the present invention; and

FIG. 4 is a block diagram showing the software configuration of the videophone apparatus shown in FIG. 3.

### DESCRIPTION OF THE PREFERRED EMBODIMENTS

### First Embodiment

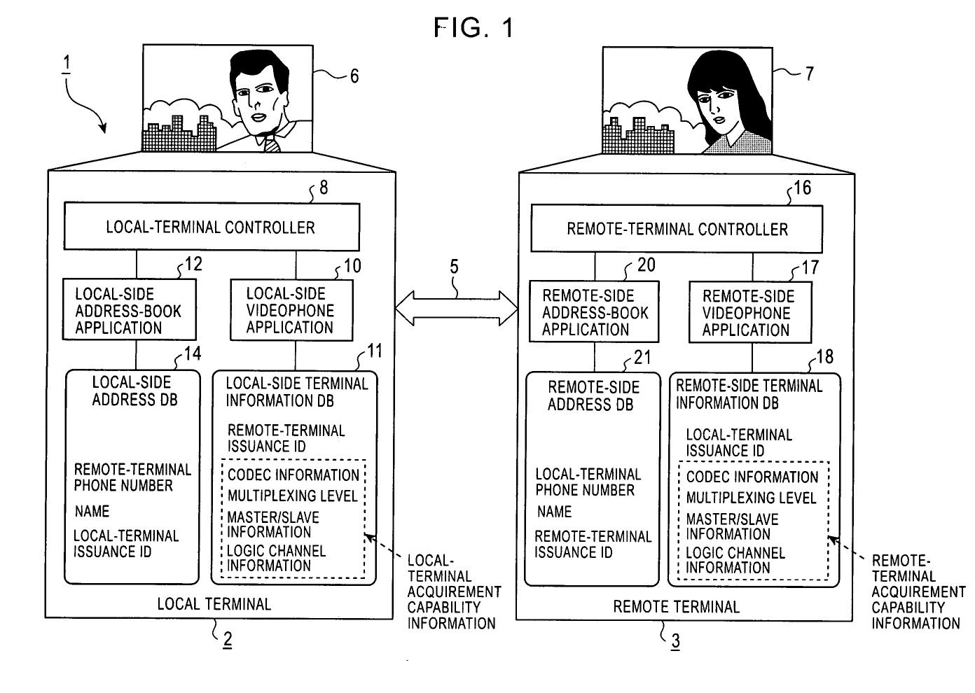

A videophone system including videophone apparatuses according to a first embodiment of the present invention will be described below with reference to FIG. 1.

As shown in FIG. 1, a videophone system 1 according to the present embodiment includes a local terminal 2, which serves as a local-side videophone apparatus, and a remote terminal 3, which serves as a remote-side videophone apparatus relative to the local terminal 2. Relative to the remote terminal 3, the local terminal 2 serves as a remote-side videophone apparatus.

Through a user's input operation of buttons (not shown) or the like, each of the local terminal 2 and the remote terminal 3 can issue a call request to the remote-side terminal 2 or 3.

In the videophone system 1 according to the present embodiment, after issuing/receiving a call request to/from the remote-side terminal 2 or 3 each having a predetermined phone number, the local terminal 2 and the remote terminal 3 exchange capability information therebetween through a communications line 5 to establish an interconnection therebetween.

In the present embodiment, the capability information is exchanged to make a multiplexing level determination for matching the multiplexing levels between the local terminal 2 and the remote terminal 3, to make a master/slave determination for defining which of the local terminal 2 and the remote terminal 3 serves as a master or slave, to exchange terminal information required for establishing the interconnection, and to open a logic channel. Examples of the terminal information include CODEC capabilities and multiplexing tables.

After an interconnection is established through the capability information exchange, the local terminal 2 and the remote terminal 3 mutually transmit/receive voice data and image data therebetween through the communications line 5, to thereby make a first phone call during which the image data received from the remote terminals 2 and 3 are displayed on corresponding display units 6 and 7.

As shown in FIG. 1, the local terminal 2 has a local-terminal controller 8, which is adapted to perform various controls for an interconnection with the remote terminal 3 and for a videophone call.

The local-terminal controller 8 may be implemented with hardware, such as a CPU (central processing unit), or may be implemented with high-order software relative to a local-side videophone application 10, a local-side terminal information database 11, a local-side address-book application 12, and a local-side address database (DB) 14, which are described below. When the local-terminal controller 8 is implemented with software, the function of the local-terminal controller 8 is executed by hardware, such as a CPU.

The local terminal 2 has the local-side videophone application 10, which is application software executed by the local-terminal controller 8.

By executing the local-side videophone application 10, the local-terminal controller 8 exchanges capability information and establishes an interconnection with the remote terminal 3.

The local terminal 2 has the local-side terminal information database (DB) 11 below the local-side videophone application 10. When the local-terminal controller 8 executes the local-side videophone application 10, data is read from or written to the local-side terminal information database 11.

That is, by executing the local-side videophone application 10, the local-terminal controller 8 causes the local-side terminal information database 11 to store the capability information acquired by the capability information exchange (this capability information will hereinafter be referred to as “local-terminal acquirement capability information”), as shown in FIG. 1. The local-terminal acquirement capability information contains CODEC information, a multiplexing level, master/slave information, and logic channel information.

When the local-terminal controller 8 issues/receives a call request to/from a videophone apparatus having a remote-terminal phone number to make a second or subsequent phone call, the local-terminal controller 8 establishes an interconnection with the remote terminal 3 by executing the local-side videophone application 10 and using the local-terminal acquirement capability information stored in the local-side terminal information database 11.

The local terminal 2 further has the local-side address-book application 12, which is application software executed by the local-terminal controller 8, and the local-side address database (DB) 14, from/to which data is read/written by the execution of the local-side address-book application 12.

Upon the execution of the local-side address-book application 12 by the local-terminal controller 8, the remote-terminal phone number, the name of the remote terminal owner, and so on are stored in the local-side address database 14.

Similarly to the local terminal 2, the remote terminal 3 has a remote-terminal controller 16, a remote-side videophone application 17, a remote-side terminal information database (DB) 18, a remote-side address-book application 20, and a remote-side address database (DB) 21.

The remote-terminal controller 16 may be implemented with hardware, such as a CPU, or may be implemented with high-order software relative to the remote-side videophone application 17, the remote-side terminal information database 18, the remote-side address-book application 20, and the remote-side address database 21.

As in the local terminal 2, by executing the local-side videophone application 17, the remote-terminal controller 16 in the remote terminal 3 causes the remote-side terminal information database 18 to store the capability information acquired by the capability information exchange (this capability information will hereinafter be referred to as “remote-terminal acquirement capability information”), as shown in FIG. 1. The remote-terminal acquirement capability information contains CODEC information, a multiplexing level, master/slave information, and logic channel information.

When the second or subsequent phone call is made between the local terminal 2 and the remote terminal 3, the remote-terminal controller 16 establishes an interconnection between the local terminal 2 and the remote terminal 3 by executing the remote-side videophone application 17 and using the remote-terminal acquirement capability information stored in the remote-side terminal information database 18.

Thus, the local terminal 2 and the remote terminal 3 mutually store the capability information (i.e., the local-terminal acquirement capability information and the remote-terminal acquirement capability information) acquired by the capability information exchange performed during the first phone call between the local terminal 2 and the remote terminal 3. The local terminal 2 and the remote terminal 3 can use the mutually-stored capability information to establish an interconnection for the second or subsequent phone call therebetween.

In addition to the configuration described above, in the present embodiment, the local-terminal controller 8 determines whether or not a videophone apparatus having the phone number of the remote terminal 3 (the phone number is a predetermined phone number and will hereinafter be referred to as a “remote-terminal phone number”), during the issuance or reception of a call request for the second or subsequent phone call, is the remote terminal 3.

When it is determined that the videophone apparatus having the remote-terminal phone number, during the issuance or reception of a call request for the second or subsequent phone call, is the remote terminal 3, the local-terminal controller 8 establishes an interconnection between the local terminal 2 and the remote terminal 3 by using the local-terminal acquirement capability information stored in the local-side terminal information database 11.

Similarly to the determination made by the local-terminal controller 8, the remote-terminal controller 16 also makes a determination with respect to the local terminal 2 acting as a remote terminal.

When it is determined that a videophone apparatus having the phone number of the local terminal 2 (the phone number is a predetermined phone number and will hereinafter be referred to as a local-terminal phone number), during the issuance or reception of a call request for the second or subsequent phone call, is the remote terminal 3, the remote-terminal controller 16 establishes an interconnection between the local terminal 2 and the remote terminal by using the remote-terminal acquirement capability information stored in the remote-side terminal information database 18.

Thus, after determining a videophone apparatus identity that corresponds to a phone number, the local terminal 2 and the remote terminal 3 can establish an interconnection for the second or subsequent phone call therebetween by using the capability information stored in the terminal information databases 11 and 18.

In addition to the above-described configuration, the videophone system 1 according to the present embodiment determines a videophone apparatus identity that corresponds to a phone number, as described below.

That is, when the communications line 5 is disconnected after the n-th phone call between the local terminal 2 and the remote terminal 3 is finished, the local terminal 2 issues a last-call ID (hereinafter referred to as a “local-terminal issuance ID) as a call identifier for identifying the n-th phone call.

Similarly, the remote terminal 3 also issues a last-call ID (hereinafter referred to as a “remote-terminal issuance ID) as a call identifier for identifying the n-th phone call between the local terminal 2 and the remote terminal 3.

By executing the local-side address-book application 12, the local-terminal controller 8 causes the issued local-terminal issuance ID to be stored in the local-side address database 14, as shown in FIG. 1.

Similarly, by executing the remote-side address-book application 20, the remote-terminal controller 16 also causes the issued remote-terminal issuance ID to be stored in the remote-side address database 21, as shown in FIG. 1.

Upon the issuance of the local-terminal issuance ID and the remote-terminal issuance ID, the local terminal 2 and the remote terminal 3 exchange the respectively issued terminal issuance IDs through the communications line 5.

By executing the local-side videophone application 10, the local-terminal controller 8 causes the remote-terminal issuance ID, obtained by the exchange of the last-call IDs, to be stored in the local-side terminal information database 11, as shown in FIG. 1.

Similarly, by executing the remote-side videophone application 17, the remote-terminal controller 16 also causes the local-terminal issuance ID, obtained by the exchange of the last-call IDs, to be stored in the remote-side terminal information database 18, as shown in FIG. 1.

When a videophone apparatus having the remote-terminal phone number, during the issuance or reception of a call request for the (n+1)th phone call, holds a last-call ID, the local-terminal controller 8 exchanges the held last-call ID and the remote-terminal issuance ID stored in the local-side terminal information database 11.

At this point, when the videophone apparatus having the remote-terminal phone number, during the issuance or reception of a call request for the (n+1)th phone call, is the remote terminal 3, the remote-terminal issuance ID stored in the local-side terminal information database 11 and the local-terminal issuance ID stored in the remote-side terminal information database 18 are exchanged.

When the local-terminal issuance ID is obtained by the exchange of the last-call IDs, i.e., when the obtained last-call ID matches the local-terminal issuance ID issued by the local terminal 2, the local-terminal controller 8 determines that the videophone apparatus having the remote-terminal phone number, during the issuance or reception of a call request for the (n+1)th phone call, is the remote terminal 3.

Similarly, when a videophone apparatus having a local-terminal phone number, during the issuance or reception of a call request for the (n+1)th phone call, holds a last-call ID, the remote-terminal controller 16 exchanges the held last-call ID and the local-terminal issuance ID stored in the remote-side terminal information database 18.

At this point, when the videophone apparatus having the local-terminal phone number, during the issuance or reception of a call request for the (n+1)th phone call, is the local terminal 2, the local-remote terminal issuance ID stored in the remote-side terminal information database 18 and the remote-terminal issuance ID stored in the local-side terminal information database 11 are exchanged.

When the remote-terminal issuance ID is by through the exchange of the last-call IDs, i.e., when the obtained last-call ID matches the remote-terminal issuance ID issued by the remote terminal 3, the remote-terminal controller 16 determines that the videophone apparatus having the local-terminal phone number, during the issuance or reception of a call request for the (n+1)th phone call, is the local terminal 2.

With this arrangement, based on the last-call IDs (the local-terminal issuance ID and the remote-terminal issuance ID) serving as call identifiers, it is possible to determine a videophone apparatus identity that corresponds to a phone number.

Since the last-call IDs issued when the communications line 5 is disconnected after the n-th phone call is finished is used as call identifiers, it is possible to issue and exchange the call identifiers without affecting the phone call.

Other methods may also be used to determine a videophone apparatus identity that corresponds to a phone number.

For example, when a videophone apparatus having a remote-terminal phone number, during the issuance or reception of a call request for the (n+1)th phone call, holds a last-call ID previously issued by the videophone apparatus, the local terminal 2 may exchange the held last-call ID and the local-terminal issuance ID stored in the local-side address database 14.

As a result of the exchange, when a remote-terminal issuance ID that is the same as the remote-terminal issuance ID stored in the local-side terminal information database 11 is obtained as a last-call ID previously issued by the videophone apparatus having the remote-terminal phone number, it may be determined that the videophone apparatus having the remote-terminal phone number, during the issuance or reception of a call request for the (n+1)th phone call, is the remote terminal 3.

In parallel, when a videophone apparatus having a local-terminal phone number, during the issuance or reception of a call request for the (n+1)th phone call, holds a last-call ID previously issued by the videophone apparatus, the remote terminal 3 may exchange the held last-call ID and the remote-terminal issuance ID stored in the remote-side address database 21.

As a result of the exchange, when a local-terminal issuance ID that is the same as the local-terminal issuance ID stored in the remote-side terminal information database 18 is obtained as a last-call ID previously issued by the videophone apparatus having the local-terminal phone number, it may be determined that the videophone apparatus having the local-terminal phone number, during the issuance or reception of a call request for the (n+1)th phone call, is the local terminal 2.

In this case as well, based on the local-terminal issuance ID and the remote-terminal issuance ID, it is possible to determine a videophone apparatus identity that corresponds to a phone number.

In addition to the above-described configuration, in the present embodiment, the local-terminal issuance ID and the remote-terminal issuance ID contain time information indicating time when the last-call IDs are issued and the communications line 5 is disconnected after the end of the n-th phone call.

With this arrangement, it is possible to issue last-call IDs containing simple information that allows appropriate determination of a videophone apparatus identity that corresponds to a phone number.

Preferably, the time information contains date and time. With such an arrangement, it is possible to issue last-call IDs that allows more appropriate determination of a videophone apparatus identity that corresponds to a phone number.

In addition to the above-described configuration, in the present embodiment, the local-terminal controller 8 causes the remote-terminal phone number, the local-terminal acquirement capability information, and the remote-terminal issuance ID obtained by the exchange of the last-call IDs, to be stored, as a set (in other words, in an associated manner), in the local-side address database 14 and the local-side terminal information database 11.

Similarly, the remote-terminal controller 16 also causes the local-terminal phone number, the remote-terminal acquirement capability information, and the local-terminal issuance ID obtained by the exchange of the last-call IDs, to be stored, as a set (in other words, in an associated manner), in the remote-side address database 21 and the remote-side terminal information database 18.

With this arrangement, during the second or subsequent phone call, the local-terminal controller 8 can promptly read the remote-terminal phone number stored in the local-side address database 14 and the local-terminal acquirement capability information and remote-terminal issuance ID stored in the local-side terminal information database 11.

Similarly, during the second or subsequent phone call, the remote-terminal controller 16 can promptly read the local-terminal phone number stored in the remote-side address database 21 and the remote-terminal acquirement capability information and local-terminal issuance ID stored in the remote-side terminal information database 18.

Consequently, the interconnection for the second or subsequent phone call between the local terminal 2 and the remote terminal 3 can be efficiently established based on the determination of a videophone apparatus identity that corresponds to a phone number and based on the capability information stored in the terminal information databases 11 and 18.

After the exchange of the last-call IDs, the local terminal 2 may store the local-terminal acquirement capability information simultaneously with the remote-terminal issuance ID. Alternatively, when the exchange of the capability information is completed, the local terminal 2 may first store only the local-terminal acquirement capability information, and when the exchange of the last-call IDs is completed, the local terminal 2 may store the remote-terminal issuance ID in association with the remote-terminal phone number and the local-terminal acquirement capability information.

Similarly, after the exchange of the last-call IDs, the remote terminal 3 may store the remote-terminal acquirement capability information simultaneously with the local-terminal issuance ID. Alternatively, when the exchange of the capability information is completed, the remote terminal 3 may first store only the remote-terminal acquirement capability information, and when the exchange of the last-call IDs is completed, the remote terminal 3 may store the local-terminal issuance ID in association with the local-terminal phone number and the remote-terminal acquirement capability information.

When a call request for the second or subsequent phone call is received or issued but an interconnection between the local terminal 2 and the remote terminal 3 cannot be established using the capability information stored in the terminal information databases 11 and 18, capability information exchange may further be performed between the local terminal 2 and the remote terminal 3.

Capability information acquired by the capability information exchange may be used to establish the interconnection.

With such an arrangement, if the local terminal 2 and the remote terminal 3 fail to establish an interconnection therebetween by using the capability information stored in the terminal information databases 11 and 18, the further capability information exchange ensures that the interconnection is established.

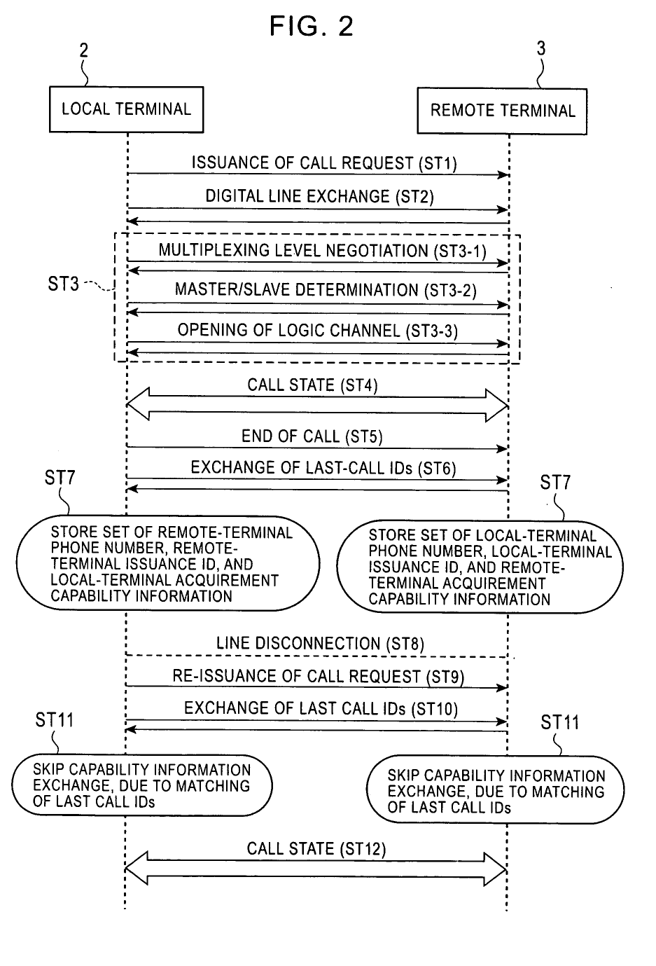

Operations of the present embodiment will be described next with reference to FIG. 2.

As shown in FIG. 2, in the present embodiment, first, in step ST1, a user using the local terminal 2 performs input operations to select a remote-terminal phone number stored in the local-side address database 14 and to issue a call request to the remote terminal 3. This process, when viewed from the remote terminal 3, means that a call request from the local terminal 2 is received.

After the local terminal 2 re-issues the call request, digital line exchange is performed in step ST2.

Next, in step ST3, capability information is exchanged between the local terminal 2 and the remote terminal 3.

Specifically, in step ST3-1, terminal information is exchanged and multiplexing-level negotiation is performed. This negotiation involves multiplexing level determination based on the exchange of the terminal information. In step ST3-2, a master and slave are determined. In step ST3-3, a logic channel is opened (established).

Consequently, an interconnection between the local terminal 2 and the remote terminal 3 is appropriately established.

Next, in step ST4, the local terminal and the remote terminal 3 are put into a call state, in which voice data obtained by a microphone (not shown) and image data obtained by a camera (not shown) are exchanged between the local terminal 2 and the remote terminal 3 through the communications line 5.

Thus, as shown in FIG. 1, the first videophone call during which the image data received from the remote-side terminals 2 and 3 are displayed on display units 6 and 7 is made.

Next, in step ST5, the first phone call between the local terminal 2 and the remote terminal 3 is finished.

Next, in step ST6, the local terminal 2 issues, as a last-call ID, a local-terminal issuance ID for identifying the first phone call, and the remote terminal 3 similarly issues, as a last-call ID, a remote-terminal issuance ID for identifying the first phone call.

Thereafter, as the exchange of the last-call IDs, the local terminal 2 and the remote terminal 3 exchange the respectively issued local-terminal issuance ID and remote-terminal issuance ID.

Next, in step ST7, the local-terminal controller 8 in the local terminal 2 causes a set of the remote-terminal phone number, the remote-terminal issuance ID obtained by the last-call ID exchange performed in step ST6, and the local-terminal acquirement capability information to be stored in the local-side address database 14 and the local-side terminal information database 11.

Consequently, a set of the remote-terminal issuance ID, the local-terminal acquirement capability information, and the remote-terminal phone number is managed.

Similarly, in step ST7, the remote-terminal controller 16 in the remote terminal 3 causes a set of the local-terminal phone number, the local-terminal issuance ID obtained by the last-call ID exchange performed in step ST6, and the remote-terminal acquirement capability information to be stored in the remote-side address database 21 and the remote-side terminal information database 18.

Consequently, a set of the local-terminal issuance ID, the remote-terminal acquirement capability information, and the local-terminal phone number is managed.

Next, in step ST8, the communications line 5 is disconnected.

The processes from step ST5 to step ST8 are sequentially performed in a short period of time, as a series of processes. Thus, substantially during the disconnection of the communications line 5, the local-terminal issuance ID and the remote-terminal issuance ID are issued and exchanged.

Next, in step ST9, the user using the local terminal 2 performs operations to re-select the remote-terminal phone number stored in the local-side address database 14 and to re-issue a call request to the videophone apparatus having the remote-terminal phone number. This process, when viewed from the remote terminal 3, means that the videophone apparatus having the local-terminal phone number receives a re-issued call request.

In the present embodiment, for convenience of description, a videophone apparatus having a remote-terminal phone number corresponds to the remote terminal 3 and a videophone apparatus having a local-terminal phone number corresponds to the local terminal 2.

Next, in step ST10, the remote-terminal issuance ID stored in the local-side terminal information database 11 in step ST7 and the local-terminal issuance ID stored in the remote-side terminal information database 18 in step ST7 are exchanged.

Next, in step ST11, since the last-call ID obtained in step S10 and the local-terminal issuance ID issued by the local terminal 2 match each other, the local-terminal controller 8 determines that the communication partner that is re-issuing the call request is the remote terminal 3.

Thus, the local terminal 2 skips the capability information exchange and establishes an interconnection with the remote terminal 3 by using the local-terminal acquirement capability information stored in the local-side terminal information database 11.

Similarly, in step ST1, since the last-call ID obtained in step S10 and the remote-terminal issuance ID issued by the remote terminal 3 match each other, the remote-terminal controller 16 determines that the communication partner that is receiving the re-issued call request is the local terminal 2.

Consequently, the remote terminal 3 skips the capability information exchange and establishes an interconnection with the local terminal 2 by using the remote-terminal acquirement capability information stored in the remote-side terminal information database 18.

Next, in step ST12, the local terminal 2 and the remote terminal 3 are put into a call state, in which the local terminal 2 and the remote terminal 3 make the second videophone call therebetween.

In this case, since capability information exchange as in step ST3 can be skipped, the local terminal 2 and the remote terminal 3 can promptly start the second videophone call.

### Second Embodiment

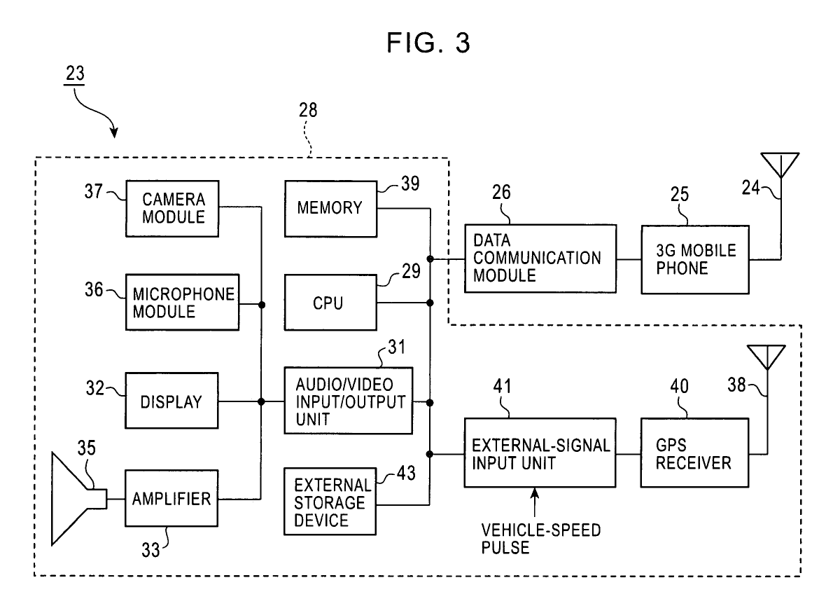

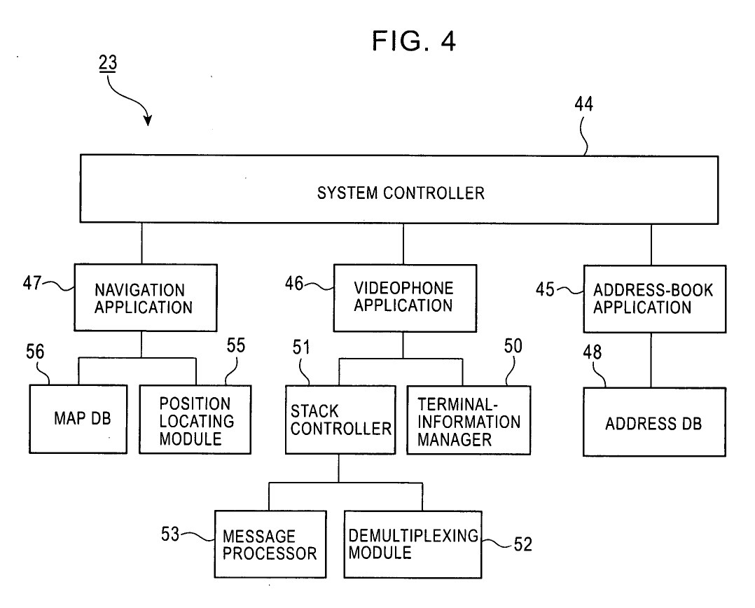

Next, a videophone apparatus, which serves as a mobile communication terminal, according to a second embodiment of the present invention will be described with reference to FIGS. 3 and 4. This videophone apparatus is incorporated into a vehicle-mounted navigation apparatus.

FIG. 3 shows the hardware configuration of a videophone apparatus 23 according to the present embodiment.

As shown in FIG. 3, the videophone apparatus 23 according to the present invention has a third-generation mobile phone 25 provided with an antenna 24.

After an interconnection with a remote-side videophone apparatus (not shown) is established, the third-generation mobile phone 25 can transmit/receive voice data and image data to/from the remote-side videophone apparatus via the antenna 24.

A data communication module 26 is connected to the third-generation mobile phone 25. The data communication module 26 provides a connection between the third-generation mobile phone 25 and a navigation apparatus main-unit 28 so as to allow data communication.

A CPU (central processing unit) 29 is connected to the data communication module 26. The CPU 29 performs various controls for an interconnection with a remote-side videophone apparatus, for a videophone call to the remote-side videophone apparatus, and for navigation.

For example, the CPU 29 performs demultiplexing processing on reception data into which voice data and image data received from the remote-side videophone apparatus were multiplexed (the voice data and the image data will hereinafter be referred to as “reception voice data” and “reception image data”, respectively) to separately obtain the reception voice data and the reception image data. Except for the reception voice data and the reception image data, the reception data may contain other multiplexed data (e.g., control data).

For example, in accordance with the multiplexing level acquired by the capability information exchange described below, the CPU 29 performs multiplexing processing on voice data and image data to be transmitted from the videophone apparatus 23 to the remote-side videophone apparatus (the voice data and the image data will hereinafter be referred to as “transmission voice data” and “transmission image data”, respectively). The CPU 29 then generates, as transmission data, the transmission voice data and the transmission image data to the data communication module 26.

Except for transmission voice data and transmission image data, the transmission data may contain other multiplexed data (e.g., control data).

The transmission data is sent from the data communication module 26 to the third-generation mobile phone 25. The transmission data is then transmitted from the third-generation mobile phone 25 to the remote-side videophone apparatus.

An audio/video input/output unit 31 is connected to the CPU 29. The reception voice data and reception image data demultiplexed by the CPU 29 are sent to audio/video input/output unit 31.

Under the control of the CPU 29, the audio/video input/output unit 31 decodes the input reception voice data and the reception image data and relays the resulting data.

A display 32, which serves as a display unit, is connected to the audio/video input/output unit 31. The decoded reception image data produced by the audio/video input/output unit 31 is sent to the display 32.

The display 32 displays the input reception image data on the screen.

An amplifier 33 is also connected to the audio/video input/output unit 31 and a speaker 35 is further connected to the amplifier 33.

The decoded reception voice data generated by the audio/video input/output unit 31 is sent to the amplifier 33.

The amplifier 33 amplifies the power of the input reception voice data and sends the resulting voice data to the speaker 35.

The speaker 35 produces voice based on the reception voice data produced by the amplifier 33.

On the other hand, a microphone module 36 is connected to the audio/video input/output unit 31. The microphone module 36 converts voice from the speech of the user into transmission voice data and generates transmission voice data.

The transmission voice data produced by the microphone module 36 is sent to the audio/video input/output unit 31. Under the control of the CPU 29, the audio/video input/output unit 31 encodes and relays the transmission voice data.

A camera module 37 is connected to the audio/video input/output unit 31. The camera module 37 converts a photographed image into transmission image data and generates the transmission image data.

The transmission image data produced by the camera module 37 is sent to the audio/video input/output unit 31. The audio/video input/output unit 31 encodes the transmission image data and generates the encoded image data.

The encoded transmission voice data and transmission image data generated by the audio/video input/output unit 31 are multiplexed by the CPU 29, as described above, and the resulting data are then transmitted to the remote-side videophone apparatus.

Thus, voice based on the reception voice data is generated from the speaker 35, while the reception image data is displayed on the display 32, and the transmission voice data sent from the microphone module 36 and the transmission image data sent from the camera module 37 can be multiplexed and be relayed to the remote-side videophone apparatus.

With this arrangement, a videophone call can be made to the remote-side videophone apparatus.

A memory 39 is connected to the CPU 29 to store software executed by the CPU 29.

By executing the software stored in the memory 39, the CPU 29 can perform various controls for an interconnection with the remote-side videophone apparatus, for a videophone call to the remote-side videophone apparatus, and for a navigation apparatus. The details of the software stored in the memory 39 will be described below.

The videophone apparatus 23 further has functions of a typical navigation apparatus.

That is, the videophone apparatus 23 has a GPS receiver 40 provided with an antenna 38. The GPS receiver 40 receives orbit and time information transmitted from a GPS satellite and generates a reception result as an external signal.

An external-signal input unit 41 is connected to the GPS receiver 40. The external signal output from the GPS receiver 40 is sent to the external-signal input unit 41. Further, a vehicle-speed pulse is sent, as an external signal, to the external-signal input unit 41.

The external-signal input unit 41 generates the input external signals, which are then sent to the CPU 29.

Based on the input external signals, the CPU 29 locates the current vehicle position. Based on the located current vehicle position, the CPU 29 determines a route to a destination set through an input operation using a touch panel or the like of the display 32.

An external storage device 43 is connected to the CPU 29 to store a map database.

During route calculation, by referring to road data stored in the map database, the CPU 29 determines a recommended route to a destination.

By using map data read from the map database, the CPU 29 creates map display data and generates the created map display data to the display 32 via the audio/video input/output unit 31.

Thus, during the execution of navigation, a map can be displayed on the screen of the display 32.

The CPU 29 creates guidance image data for guiding the vehicle to a destination along the recommended route to the destination, the recommended route being determined by the route calculation, and sends the created guidance image data to the display 32 via the audio/video input/output unit 31.

Thus, during the execution of navigation, guidance images, such as an enlarged intersection image and lane guidance image, are appropriately displayed on the screen of the display 32.

Further, the CPU 29 creates voice guidance data for guiding the vehicle to a destination along the recommended route to the destination, the recommended route being determined by the route calculation, and sends the created voice guidance data to the speaker 35 via the audio/video input/output unit 31 and the amplifier 33.

Thus, during the execution of navigation, the speaker 35 appropriately provides voice guidance for intersection left/right-turn guidance and so on.

FIG. 4 is a block diagram of the software stored in the memory 39 in the videophone apparatus 23 shown in FIG. 3. As shown in FIG. 4, the videophone apparatus 23 has a system controller 44 for controlling the entire system of the videophone apparatus 23. The system controller 44 is executed by the CPU 29.

The videophone apparatus 23 has an address-book application 45, a videophone application 46, and a navigation application 47, as low-order software relative to the system controller 44.

The address-book application 45 and the videophone application 46 may be read and obtained from the third-generation mobile phone 25.

An address database 48 is provided below the address-book application 45. When the CPU 29 executes the address-book application 45 via the system controller 44, data is read from or written to the address database 48.

For example, upon the execution of the address-book application 45, the phone number of a remote-side videophone apparatus (the phone number will hereinafter be referred to as a “remote-side phone number”) and the user's name of the remote-side videophone apparatus are stored in the address database 48.

A terminal-information manager 50 is provided below the videophone application 46. When the CPU 29 executes the videophone application 46 via the system controller 44, data is read from and/or written to the terminal-information manager 50.

A stack controller 51 is further provided below the videophone application 46. A demultiplexing module 52 and a message processor 53 are provided below the stack controller 51.

When the CPU 29 executes the videophone application 46 via the system controller 44, the stack controller 51 operates the demultiplexing module 52 and the message processor 53, which are low-order software.

The demultiplexing module 52 sets the above-mentioned multiplexing table required for data multiplexing and demultiplexing.

The message processor 53 controls the audio/video input/output unit 31 to encode or decode voice data and image data in accordance with a predetermined encoding/decoding system.

A position locating module 55 and a map database 56 are provided below the navigation application 47.

When the CPU 29 executes the navigation application 47 via the system controller 44, the position locating module 55 locates the current vehicle position.

When the CPU 29 executes the navigation application 47 via the system controller 44, map data is read from the map database 56. The map database 56 may be read from the external storage device 43.

In the videophone apparatus 23 according to the present embodiment having the above-described basic configuration, The CPU 29 executes the videophone application 46 via the system controller 44 to issue or receive a call request to a remote-side videophone apparatus (not shown) having a remote phone number and then performs capability information exchange with the remote-side videophone apparatus through a communications line (not shown) to establish an interconnection with the remote-side videophone apparatus.

As in the first embodiment, the capability information exchange is performed to make a multiplexing-level determination for matching the multiplexing levels of the videophone apparatus 23 and the remote-side videophone apparatus, to make a master/slave determination for defining which of the videophone apparatus 23 and the remote-side videophone apparatus is used as a master or slave, to exchange terminal information such as CODEC capabilities and multiplexing tables, and to establish a logic channel.

After the interconnection based on the capability information exchange is established, the videophone apparatus 23 transmits/receives voice data and image data to/from the remote-side videophone apparatus through the communications line to thereby make the first phone call while the display 32 displays the image data received from the remote-side videophone apparatus.

By executing the videophone application 46 via the system controller 44, the CPU 29 causes a terminal-information manager 50 to store, as capability information acquired by the capability information exchange, the CODEC information, the multiplexing level, the master/slave information, and the logic channel information.

When a call request is issued to or received from a videophone apparatus having a remote-side phone number to make the second or subsequent phone call to the remote-side videophone apparatus, the CPU 29 establishes an interconnection with the remote-side videophone apparatus by executing the videophone application 46 via the system controller 44 and using the capability information stored in the terminal-information manager 50.

As described above, the remote-side phone number is stored in the address database 48.

Thus, the videophone apparatus 23 can store the capability information acquired by the capability information exchange performed during the first phone call to the remote-side videophone apparatus and can establish an interconnection for the second or subsequent phone call by using the stored capability information.

The remote-side videophone apparatus also has hardware and software configurations (not shown) similar to those of the videophone apparatus 23.

For example, the remote-side videophone apparatus includes a CPU (hereinafter referred to as a “remote-side CPU”), a system controller (hereinafter referred to as a “remote-side system controller”), a videophone application (hereinafter referred to as a “remote-side videophone application”), a terminal information manager (hereinafter referred to as a “remote-side terminal information manager”), an address-book application (hereinafter referred to as a “remote-side address-book application”), and an address database (hereinafter referred to as a “remote-side address database”), which are similar to those in the videophone apparatus 23.

Similarly to the videophone apparatus 23, the remote-side CPU in the remote-side videophone apparatus executes the remote-side videophone application via the remote-side system controller to thereby store capability information (hereinafter referred to as “remote-side acquirement capability information), acquired by the capability information exchange, to be stored in the remote-side terminal information manager.

For making the second or subsequent phone call to the videophone apparatus 23, by executing the remote-side videophone application via the remote-side system controller and using the remote-side acquirement capability information stored in the remote-side information manager, the remote-side CPU establishes an interconnection with the videophone apparatus 23.

Thus, the remote-side videophone apparatus can store the remote-side acquirement capability information acquired by the capability information exchange performed during the first phone call to the videophone apparatus 23 and can establish an interconnection for the second or subsequent phone call by using the stored remote-side capability information.

In the remote-side videophone apparatus, the local-side phone number is stored in the remote-side address database.

In addition to the configuration described above, the CPU 29 in the present embodiment further determines whether or not a videophone apparatus having a remote-side phone number, during the issuance or reception of a call request for the second or subsequent phone call, is the remote-side videophone apparatus of interest.

When it is determined that the videophone apparatus having a remote-side phone number, during the issuance or reception of a call request for the second or subsequent phone call, is the remote-side videophone apparatus of interest, the CPU 29 establishes an interconnection with the remote-side videophone apparatus by using the capability information stored in the terminal information manager 50.

With this arrangement, after determining a videophone apparatus identity that corresponds to a phone number, the videophone apparatus 23 can establish an interconnection for the second or subsequent phone call to the remote-side videophone apparatus by using the capability information stored in the terminal-information manager 50.

Similarly to the determination made by the CPU 29, a remote-terminal CPU also makes a determination with respect to the videophone apparatus 23 acting as a remote terminal.

When a videophone apparatus having the phone number of the videophone apparatus 23 (the phone number will hereinafter be referred to as a “local-side phone number), during the issuance or reception of a call request for the second or subsequent phone call, is the videophone apparatus 23, the remote-side CPU establishes an interconnection with the videophone apparatus 23 by using the remote-side acquirement capability information stored in the remote-side terminal information manager.

With this arrangement, similarly to the videophone apparatus 23, after determining a videophone apparatus identity that corresponds to a phone number, the remote-side videophone apparatus can also establish an interconnection for the second or subsequent phone call to the videophone apparatus 23 by using the remote-side acquirement capability information stored in the remote-side terminal information manager.

In addition to the configuration described above, the videophone apparatus 23 of the present embodiment determines a videophone apparatus identity that corresponds to a phone number, as follows.

That is, during the disconnection of the communications line after the end of the n-th phone call to the remote-side videophone apparatus, the videophone apparatus 23 issues a last-call ID (hereinafter referred to as a “local-terminal issuance ID) as a call identifier for identifying the n-th phone call.

Similarly, the remote-side videophone apparatus issues a last-call ID (hereinafter referred to as a remote-terminal issuance ID) as a call identifier for identifying the n-th phone call to the videophone apparatus 23.

By executing the address-book application 45 via the system controller 44, the CPU 29 causes the issued local-terminal issuance ID to be stored in the address database 48.

Similarly, by executing the remote-side address-book application via the remote-side system controller, the remote-side CPU causes the issued remote-terminal issuance ID to be stored in the remote-side terminal information manager.

Upon the issuance of the local-terminal issuance ID and the remote-terminal issuance ID, the videophone apparatus 23 and the remote-side videophone apparatus exchange the respectively issued terminal issuance IDs through the communications line.

By executing the videophone application 46 via the system controller 44, the CPU 29 causes the remote-terminal issuance ID, obtained by the exchange of the last-call IDs, to be stored in the terminal-information manager 50.

Similarly, by executing the remote-side videophone application via the remote-side system controller, the remote-side CPU causes the local-terminal issuance ID, obtained by the exchange of the last-call IDs, to be stored in the remote-side information manager.

When a videophone apparatus having a remote-side phone number, during the issuance or reception of a call request for the (n+1)th phone call, holds a last-call ID, the videophone apparatus 23 exchanges the held last-call ID and the remote-terminal issuance ID stored in the terminal-information manager 50.

When the local-terminal issuance ID is acquired by the last-call ID exchange, the CPU 29 determines that the videophone apparatus having the remote-side phone number, during the issuance or reception of a call request for the (n+1)th phone call, is the remote-side videophone apparatus of interest.

With this arrangement, the videophone apparatus 23 can determine a videophone apparatus identity that corresponds to a phone number, based on the last-call IDs (i.e., the local-terminal issuance ID and the remote-terminal issuance ID) serving as call identifiers.

Since the last-call IDs issued during the disconnection of the communications line after the end of the n-th phone call are used as call identifiers, the call identifiers can be issued and exchanged at a point when the phone call is not affected.

Similarly, when a videophone apparatus having a local-side phone number, during the issuance or reception of a call request for the (n+1)th phone call, holds a last-call ID, the remote-side videophone apparatus also exchanges the held last-call ID and the local-terminal issuance ID stored in the remote-side terminal-information manager.

When the remote-terminal issuance ID is acquired by the last-call ID exchange, the remote-side CPU determines that the videophone apparatus having the local-side phone number, during the issuance or reception of a call request for the (n+1)th phone call, is the videophone apparatus 23.

Thus, similarly to the videophone apparatus 23, the remote-side videophone apparatus can determine a videophone apparatus identity that corresponds to a phone number, based on the last-call IDs serving as call identifiers.

A configuration other than the above-described configuration may be used to determine a videophone apparatus identity that corresponds to a phone number.

For example, when the videophone apparatus 23 determines that a videophone apparatus having a remote-side phone number, during the issuance or reception of a call request for the (n+1)th phone call, holds a last-call ID previously issued by the videophone apparatus, the videophone apparatus 23 may exchange the held last-call ID and the local-terminal issuance ID stored in the address database 48.

As a result of the exchange, when the same remote-terminal issuance ID as the remote-terminal issuance ID stored in the terminal-information manager 50 is obtained as a last-call ID previously issued by the videophone apparatus having the remote-side phone number, the videophone apparatus 23 may determine that the videophone apparatus having the remote-side phone number used during the issuance or reception of a call request for the (n+1)th phone call is the remote-side videophone apparatus of interest.

Similarly, when a videophone apparatus having a local-side phone number, during the issuance or reception of a call request for the (n+1)th phone call, holds a last-call ID previously issued by the videophone apparatus, the remote-side videophone apparatus may also exchange the held last-call ID and the remote-terminal issuance ID stored in the remote-side address database.

As a result of the exchange, when the same local-terminal issuance ID as the local-terminal issuance ID stored in the remote-side terminal-information manager is obtained as a last-call ID previously issued by the videophone apparatus having the local-side phone number, the remote-side videophone apparatus may also determine that the videophone apparatus having the local-side phone number, during the issuance or reception of a call request for the (n+1)th phone call, is the videophone apparatus 23.

Thus, a videophone apparatus identity that corresponds to a phone number can be determined based on the local-terminal issuance ID and the remote-terminal issuance ID.

In the present embodiment, in addition to the configuration described above, the local-terminal issuance ID and the remote-terminal issuance ID contain time information indicating time when those last-call IDs are issued and the communications line is disconnected after the end of the n-th phone call.

With this arrangement, it is possible to issue last-call IDs containing simple information that allows appropriate determination of a videophone apparatus identity that corresponds to a phone number.

Preferably, the time information contains date and time. With this arrangement, it is possible to issue last-call IDs that allows more appropriate determination of a videophone apparatus identity that corresponds to a phone number.

In addition to the configuration described above, by executing the address-book application 45 and the videophone application 46 via the system controller 44, the CPU 29 causes the remote-side phone number, the capability information acquired by the capability information exchange, and the remote-terminal issuance ID acquired by the last-call ID exchange to be stored, as a set (in other words, in an associated manner), in the address database 48 and the terminal-information manager 50.

Thus, during the second or subsequent phone call, the CPU 29 can promptly read the remote-side phone number stored in the address database 48 and the capability information and the remote-terminal issuance ID stored in the terminal-information manager 50.

Consequently, the videophone apparatus 23 can efficiently establish an interconnection for the second or subsequent phone call to the remote-side videophone apparatus, based on the determination of a videophone apparatus identity that corresponds to a phone number and based on the capability information stored in the terminal-information manager 50.

Similarly, by executing the remote-side address-book application and the remote-side videophone application via the remote-side system controller, the remote-side CPU also causes the local-side phone number, the remote-side acquirement capability information, and the local-terminal issuance ID acquired by the last-call ID exchange to be stored, as a set (in other words, in an associated manner), in the remote-side address database and the remote-side terminal-information manager.

Thus, during the second or subsequent phone call, the remote-side CPU can promptly read the local-side phone number stored in the remote-side address database and the remote-side acquirement capability information and the local-terminal issuance ID stored in the remote-side terminal-information manager.

Consequently, the remote-side videophone apparatus can efficiently establish an interconnection for the second or subsequent phone call to the videophone apparatus 23, based on the determination of a videophone apparatus identity that corresponds to a phone number and based on the remote-terminal acquirement capability information stored in the remote-side terminal-information manager.

After the exchange of the last-call IDs, the videophone apparatus 23 may store the capability information simultaneously with the remote-terminal issuance ID. Alternatively, when the capability information exchange is completed, the videophone apparatus 23 may first store only the capability information, and when the exchange of the last-call IDs is completed, the videophone apparatus 23 may store the remote-terminal issuance ID in association with the remote-terminal phone number and the capability information.

Similarly, after the exchange of the last-call IDs, the remote-side videophone apparatus may store the remote-terminal acquirement capability information simultaneously with the local-terminal issuance ID. Alternatively, when the capability information exchange is completed, the remote-side videophone apparatus may first store only the remote-terminal acquirement capability information, and when the exchange of the last-call IDs is completed, the remote-side videophone apparatus may store the local-terminal issuance ID in association with the local-terminal phone number and the remote-terminal acquirement capability information.

When the videophone apparatus 23 issues or receives a call request for the second or subsequent phone call but cannot establish an interconnection with the remote-side videophone apparatus by using the capability information stored in the terminal-information manager 50, the videophone apparatus 23 may exchange the capability information with the remote-side videophone apparatus. The videophone apparatus 23 may then establish an interconnection by using the capability information acquired by the capability information exchange.

With this arrangement, even when the videophone apparatus 23 fails to establish an interconnection with the remote-side videophone apparatus by using the capability information stored in the terminal-information manager 50, the videophone apparatus 23 can reliably establish an interconnection by performing further capability-information exchange.

According to the videophone apparatus 23 according to the second embodiment, even when the videophone apparatus 23 is incorporated into a vehicle-mounted navigation apparatus that serves as a mobile communication terminal, the videophone apparatus 23 can store capability information acquired by capability information exchange performed during the previous phone call to the remote-side videophone apparatus and can establish an interconnection for a subsequent phone call to the remote-side videophone apparatus by using the stored capability information.

As described above, according to the present embodiment, capability information acquired by capability information exchange performed during the previous phone call to the remote-side videophone apparatus can be stored and an interconnection for a subsequent phone call to the remote-side videophone apparatus can be established by using the stored capability information.

As a result, waiting time until a videophone call is started can be reduced and a connection fee charged to the user can be reduced.

The present invention is not limited to the above-described embodiments, and various changes can be made thereto, as needed.

For example, the local terminal 2 (or the videophone apparatus 23) may simultaneously make a phone call to multiple remote terminals 3 (i.e., remote-side videophone apparatuses).

With such an arrangement, even when a phone call is simultaneously made to multiple remote-side videophone apparatuses, capability information acquired by capability information exchange performed during the previous phone call to each remote-side videophone apparatus can be stored and an interconnection for a subsequent phone call to each remote-side videophone apparatus can be established by using the stored capability information.

Even when a phone call is simultaneously made to multiple remote-side videophone apparatuses, waiting time until a videophone call is started can be reduced and a connection fee charged to the user can be reduced.

Through communication using a memory card or mail, part of the capability information may be pre-exchanged with the remote-side videophone apparatus, without the issuance or reception of a call request to or from the phone number of the remote-side videophone apparatus.

With such an arrangement, even for making a phone call to a partner for the first time, waiting time until a videophone call is started can be reduced and a connection fee charged to the user can be reduced.

In addition, the videophone apparatus according to the present invention may be incorporated into a mobile phone serving as a mobile terminal.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A videophone operable to perform, after issuing or receiving a call request to or from a remote videophone having a predetermined phone number, capability information exchange with the remote videophone through a communications line and to transmit and receive voice and image data to and from the remote videophone through the communications line to thereby make a phone call involving the display of the image data received from the remote videophone, the videophone comprising:
a storage unit that stores capability information acquired by the capability information exchange; and
a controller operable to establish an interconnection with the remote videophone by using the capability information stored in the storage unit upon issuing or receiving a call request to or from a second remote videophone having the predetermined phone number to thereby make a subsequent phone call to the remote videophone.

2. The videophone according to claim 1, wherein when the establishment of an interconnection between the videophone and the remote videophone fails using the stored capability information, the controller is operable perform additional capability information exchange with the remote videophone to establish the interconnection by using additional capability information acquired by the additional capability information exchange.

3. The videophone according to claim 1, wherein the controller is operable to perform at least part of the capability information exchange with the remote videophone in advance, without issuing or receiving a call request to or from the remote videophone.

4. The videophone according to claim 1, wherein the controller is operable to determine whether or not the second remote videophone is the remote videophone; and when it is determined that the second remote videophone is the remote videophone, the controller establishes an interconnection with the remote videophone by using the capability information stored in the storage unit.

5. The videophone according to claim 4, wherein the controller exchanges a first call identifier issued by the videophone and a second call identifier issued by the remote videophone, the first and second call identifiers identifying the n-th phone call, where n is a natural number, and the controller directs that the second call identifier issued by the remote videophone is stored in the storage unit; and
during the issuance or reception of a call request for the (n+1)th phone call, if the second remote videophone having the predetermined phone number stores a call identifier, the controller exchanges the call identifier stored by the second remote videophone and the second call identifier, and when the first call identifier issued by the videophone is acquired by the exchange, the controller determines that the second remote videophone is the remote videophone.

6. The videophone according to claim 4, wherein the controller exchanges a first call identifier issued by the videophone and a second call identifier issued by the remote videophone, the first and second call identifiers identifying the n-th phone call, where n is a natural number, and the controller directs that the second call identifier issued by the remote videophone is stored in the storage unit; and
during the issuance or reception of a call request for the (n+1)th phone call, if the second remote videophone stores a call identifier previously issued by the second remote videophone, the controller exchanges the call identifier stored by the second remote videophone and the first call identifier, and when the second call identifier issued by the remote videophone and stored in the storage unit is acquired by the exchange, the controller determines that the second remote videophone is the remote videophone.

7. The videophone according to claim 6, wherein the controller issues and exchanges the first call identifier for identifying the n-th phone call when the communications line is disconnected after the n-th phone call to the remote videophone is finished.

8. The videophone according to claim 6, wherein the storage unit stores the phone number of the remote videophone, the capability information acquired by the capability information exchange, and the second call identifier issued by the remote videophone.

9. The videophone according to claim 8, wherein the call identifiers comprise time information indicating the time when the call identifiers are issued.

10. The videophone according to claim 9, wherein the time information comprises the date and time.

11. A videophone transmission/reception method comprising a local videophone and a remote videophone having a predetermined phone number, wherein after issuing or receiving a call request to or from the remote videophone, the local videophone is operable to perform capability information exchange with the remote videophone through a communications line and to transmit and receive voice and image data to and from the remote videophone to thereby make a phone call involving the display of the image data received from the remote videophone, the method comprising:
directing the local videophone and the remote videophone to mutually store capability information acquired by the capability information exchange; and
directing the local videophone to establish an interconnection with the remote videophone by using the mutually stored capability information upon the issuance or reception of a call request to or from a second remote videophone having the predetermined phone number to thereby make a subsequent phone call with the remote videophone.

12. The videophone transmission/reception method according to claim 11, wherein when the establishment of an interconnection between the local videophone and the remote videophone fails using the mutually stored capability information, additional capability information exchange is performed with the remote videophone to establish the interconnection.

13. The videophone transmission/reception method according to claim 11, wherein at least part of the capability information exchange with the remote videophone can be performed without issuing or receiving a call request to or from the remote videophone.

14. The videophone transmission/reception method according to claim 11, comprising determining whether or not the second remote videophone having the predetermined phone number is the remote videophone; and when it is determined that the second remote videophone is the remote videophone, an interconnection with the remote videophone is established by using the mutually stored capability information.

15. The videophone transmission/reception method according to claim 14, wherein a first call identifier issued by the local videophone and a second call identifier issued by the remote videophone are exchanged, the first and second call identifiers identifying the n-th phone call, where n is a natural number, and the second call identifier issued by the remote videophone is stored by the local videophone; and
during the issuance or reception of a call request for the (n+1)th phone call, if the second remote videophone having the predetermined phone number stores a call identifier, the call identifier stored by the second remote videophone and the second call identifier issued by the remote videophone are exchanged to facilitate the determination of whether the second remote videophone is the remote videophone.

16. The videophone transmission/reception method according to claim 14, wherein a first call identifier issued by the local videophone and a second call identifier issued by the remote videophone are exchanged, the first and second call identifiers identifying the n-th phone call, where n is a natural number, and the second call identifier issued by the remote videophone is stored by the local videophone; and
during the issuance or reception of a call request for the (n+1)th phone call, if the second remote videophone having the predetermined phone number stores a call identifier previously issued by the second remote videophone, the call identifier stored by the second remote videophone and the call identifier issued by the local videophone are exchanged to facilitate the determination of whether the second remote videophone is the remote videophone.

17. A videophone system comprising:
multiple videophones, including a local videophone and at least one remote videophone having a predetermined phone number,
wherein after issuing or receiving a call request to or from the at least one remote videophone, the local videophone is operable to perform capability information exchange with the at least one remote videophone through a communications line and to transmit and receive voice and image data to and from the at least one remote videophone through the communications line to thereby make a phone call involving the display of the image data received from the at least one remote videophone, and
wherein each of the multiple videophones comprises a storage unit that stores capability information acquired by the capability information exchange and a controller, wherein, upon issuing or receiving a call request to or from a second remote videophone having the predetermined phone number to thereby make a subsequent phone call to the at least one remote videophone, the controller causes the local videophone to establish an interconnection with the at least one remote videophone by using the mutually stored capability information.

18. The videophone system according to claim 17, wherein at least one of the multiple videophones is incorporated into a mobile communication terminal.

19. The videophone system according to claim 17, wherein at least one of the multiple videophones is incorporated into a vehicle-mounted navigation apparatus and image data is displayed on a display unit of the navigation apparatus.

20. The videophone system according to claim 17, wherein the local videophone simultaneously makes a phone call to multiple remote videophones.
